(19) United States
(12) Patent Application Publication
(10) Pub. No.: US 2019/0285427 A1
(43) Pub. Date: Sep. 19, 2019

(54) COMMUNICATION DEVICE AND SCHEDULE CREATION METHOD

(71) Applicants: DENSO TEN Limited, Kobe-shi (JP); SUBARU CORPORATION, Tokyo (JP)

(72) Inventors: Shizuka TAMURA, Kobe-shi (JP); Yukisuke OZAKI, Kobe-shi (JP); Tomofumi SODA, Kobe-shi (JP); Yoshitaka HIRASHIMA, Kobe-shi (JP); Satoru IKEDA, Kobe-shi (JP); Mitsuru SASAKI, Kobe-shi (JP); Tsuyoshi KANEKO, Kobe-shi (JP); Hiroshi NOMOTO, Tokyo (JP)

(73) Assignees: DENSO TEN Limited, Kobe-shi (JP); SUBARU CORPORATION, Tokyo (JP)

(21) Appl. No.: 16/293,224

(22) Filed: Mar. 5, 2019

(30) Foreign Application Priority Data
Mar. 16, 2018 (JP) 2018-050184

(51) Int. Cl. G01C 21/34

(52) U.S. Cl. CPC G01C 21/3484; G01C 21/3415

(57) ABSTRACT

A communication device according to an embodiment includes a calculation unit, a prediction unit, and a creation unit. The calculation unit calculates a probability that a terminal device actually moves on each movement route that is predicted based on a movement history of the terminal device. The prediction unit predicts a communication quality on the movement route with the probability that is calculated by the calculation unit. The creation unit creates a communication schedule of data communication for the terminal device based on the probability on each movement route that is calculated by the calculation unit and the communication quality that is predicted by the prediction unit.

### CROSS-REFERENCE TO RELATED APPLICATION

This application is based upon, and claims the benefit of priority to, Japanese Patent Application No. 2018-050184 filed on Mar. 16, 2018, the entire contents of which are herein incorporated by reference.

### FIELD

An aspect of an embodiment relates to a communication device and a schedule creation method.

### BACKGROUND

Conventionally, there is, for example, a communication device that collects particular data from a terminal device such as a navigation device of a vehicle. In such a communication device, scheduling of data communication is executed for each terminal device based on a predicted communication quality, so that an increase in communication traffic is prevented (see, for example, Japanese Patent Application Publication No. 2008-199381).

For example, such a communication device predicts a movement route of a terminal device and creates a schedule of optimum data communication on the predicted movement route.

However, in a conventional technique, only one movement route is predicted, so that a case where the predicted movement route does not coincide with an actual movement route is not assumed. Hence, in a case where an actual movement deviates from a predicted movement route, a communication band may be strained.

### SUMMARY

According to an aspect of an embodiment, a communication device includes a calculation unit that calculates a probability that a terminal device actually moves on each movement route that is predicted based on a movement history of the terminal device, a prediction unit that predicts a communication quality on the movement route with the probability that is calculated by the calculation unit, and a creation unit that creates a communication schedule of data communication for the terminal device based on the probability on each movement route that is calculated by the calculation unit and the communication quality that is predicted by the prediction unit.

### BRIEF DESCRIPTION OF DRAWINGS

FIG. 1A is a diagram illustrating an outline of a schedule creation method.

FIG. 1B is a diagram illustrating an outline of a communication system.

FIG. 2 is a block diagram of an on-vehicle device.

FIG. 3 is a block diagram of a communication device.

FIG. 4 is a diagram illustrating a specific example of a communication quality.

FIG. 5A is a diagram (part 1) illustrating a relationship between a running probability and a communication quality.

FIG. 5B is a diagram (part 2) illustrating a relationship between a running probability and a communication quality.

FIG. 6 is a flowchart illustrating steps of a process that is executed by a communication device.

FIG. 7 is a flowchart illustrating steps of a process that is executed by an on-vehicle device.

### DESCRIPTION OF EMBODIMENT

Hereinafter, a communication device and a schedule creation method according to an embodiment will be explained in detail with reference to the accompanying drawings. Additionally, this invention is not limited by the present embodiment.

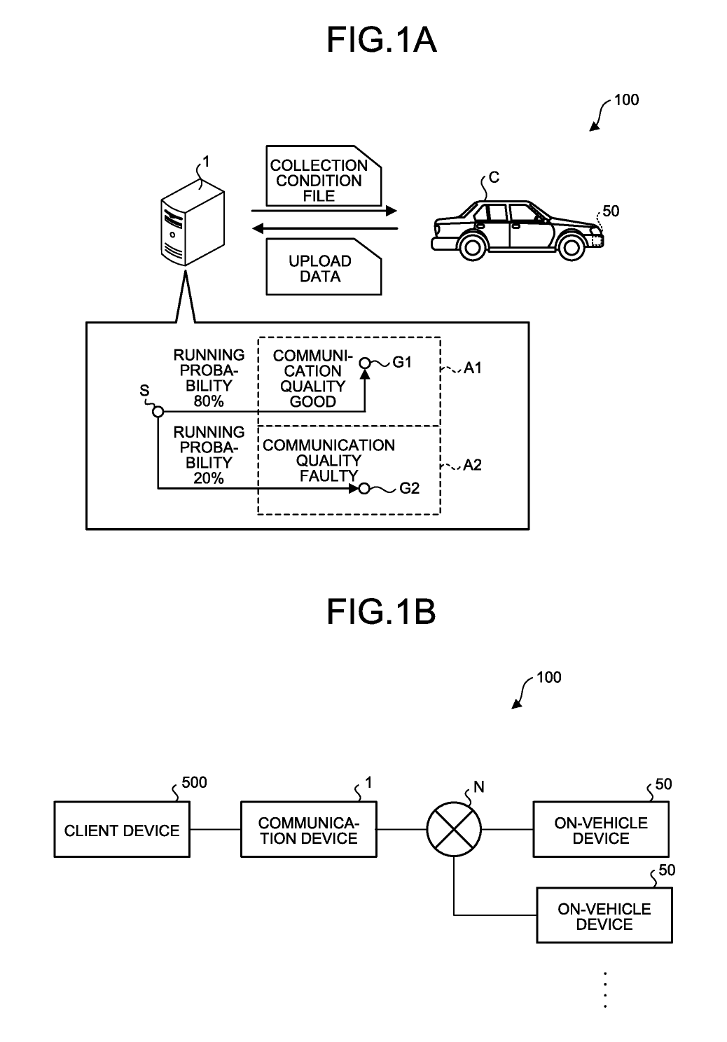

First, an outline of a schedule creation method according to an embodiment will be explained by using FIG. 1A. FIG. 1A is a diagram illustrating an outline of a schedule creation method. Additionally, a case where a terminal device is an on-vehicle device 50 will be provided as an example and explained in the present embodiment.

Furthermore, a schedule creation method according to an embodiment is executed by a communication device 1 as illustrated in FIG. 1A. The communication device 1 is, for example, a server device that collects running data of a vehicle C, infrastructure data around the vehicle C, or the like from the on-vehicle device 50.

The communication device 1 analyzes or processes collected data to add an additional value to such data and provide them to a client. For example, the communication device 1 creates a collection condition file where a data item that is a target of collection is specified according to a request of a client, and transmits it to the on-vehicle device 50.

Then, the on-vehicle device 50 uploads upload data that correspond to such a collection condition file onto the communication device 1. However, it may be impossible to execute uploading on the communication device 1 at timing when the on-vehicle device 50 acquires data that are a target of collection.

Hence, a conventional technique may predict each of a running route to a goal for a vehicle and a communication quality on the running route and optimize a communication schedule for the predicted running route. However, in a conventional technique, a case where a predicted running route deviates from an actual running route, that is, a case where a predicted running route differs therefrom is not considered.

Specifically, in a conventional technique, as data are uploaded according to a communication schedule in a case where an actual running route deviates from a predicted running route, an increase in communication traffic, that is, strain of a communication band may rather be caused.

Hence, in a schedule creation method according to an embodiment, a probability of running actually on each predicted running route for a vehicle C is calculated and a communication schedule of the on-vehicle device 50 is created based on such a probability on each running route.

Specifically, as illustrated in FIG. 1A, in a schedule creation method according to an embodiment, first, a running probability is calculated, for example, in a case where a user turns on an ignition switch at a starting point S for a vehicle C.

For example, in a schedule creation method according to an embodiment, it is possible to calculate a running probability based on a past running history of a vehicle C. Herein, a running history includes information such as a point of time when a vehicle C starts running thereof, a running route, or a goal.

That is, in a schedule creation method according to an embodiment, a regularity of a running route for a vehicle C is derived from a running history of the vehicle C and a running probability is calculated for each running route based on such a regularity.

An example as illustrated in FIG. 1A illustrates a case where a running probability that a vehicle C runs from a starting point S to a goal G1 that is included in a communication area A1 is 80% while a running probability that it runs from the starting point S to a goal G2 that is included in a communication area A2 is 20%.

Furthermore, although a case where a running probability is calculated for one on-vehicle device 50 is illustrated herein, a running probability is similarly calculated for a plurality of on-vehicle devices 50 in a schedule creation method according to an embodiment.

That is, in a schedule creation method according to an embodiment, in a case where it is possible for each vehicle C to run on a plurality of running routes, which running route each vehicle C runs on, that is, which communication area it runs in, is predicted based on a running probability. In other words, in a schedule creation method according to an embodiment, it is possible to predict a transition of the number of vehicles C with a temporal change in each communication area.

Subsequently, in a schedule creation method according to an embodiment, a communication quality is predicted for each of a communication area A1 and a communication area A2. An example as illustrated in FIG. 1A illustrates a case where a communication quality of a communication area A1 is good and illustrates a case where a communication quality of a communication area A2 is faulty.

Furthermore, in an example as illustrated in FIG. 1A, a running probability that a vehicle C runs in a communication area A1 is high, so that, in a schedule creation method according to an embodiment, a communication schedule is created in such a manner that communication of a large volume of data to the on-vehicle device 50 is started.

On the other hand, in a case where a running probability for a communication area A2 where a communication quality is predicted to be faulty is high, a communication schedule is created in such a manner that an amount of data is reduced or data communication is not executed.

Thus, in a schedule creation method according to an embodiment, a communication schedule that defines an amount of data that are uploaded by the on-vehicle device 50 or timing of uploading thereby is created for each on-vehicle device 50 so that a communication band in each communication area is not strained.

Therefore, due to a schedule creation method according to an embodiment, it is possible to optimize a communication band.

Next, a communication system 100 according to an embodiment will be explained by using FIG. 1B. FIG. 1B is a diagram illustrating an outline of the communication system 100. As illustrated in FIG. 1B, the communication system 100 includes a client device 500 in addition to the communication device 1 and the on-vehicle device 50 as described above.

The client device 500 is a device that is managed by a client (a customer from the viewpoint of the communication device 1) that utilizes data that are collected by the communication device 1. The client device 500 acquires data that are collected from each on-vehicle device 50 by the communication device 1 and provides a predetermined service based on such data.

For example, a manager of the client device 500 operates the client device 500, sets a desired data collection condition, and notifies the communication device 1 of such a collection condition.

Such a collection condition includes data to be collected, a condition of a vehicle that is a target of collection of data, a collection trigger that specifies collection starting and ending trigger patterns, a method for reduction of data, upload timing, or the like.

As the communication device 1 acquires a collection condition, first, selection of a vehicle C that collects data, that is, the on-vehicle device 50 is executed based on such a collection condition. Subsequently, the communication device 1 creates a communication schedule of each selected on-vehicle device 50 and transmits a collection condition file as described above to each on-vehicle device 50 through a network N.

In a case where each on-vehicle device 50 acquires data that correspond to such a collection condition file, such data are uploaded onto the communication device 1 through the network N according to a communication schedule.

Then, the client device 500 appropriate takes, from the communication device 1, data that are collected from each on-vehicle device 50 by the communication device 1, to provide a predetermined service based on such data.

Additionally, although a case where one client device 500 is provided is illustrated herein, a plurality of client devices 500 may be provided or such a client device 500 may be integrated with the communication device 1. Furthermore, the client device 500 may collect data directly from each on-vehicle device 50 according to a collection condition file that is created by the communication device 1.

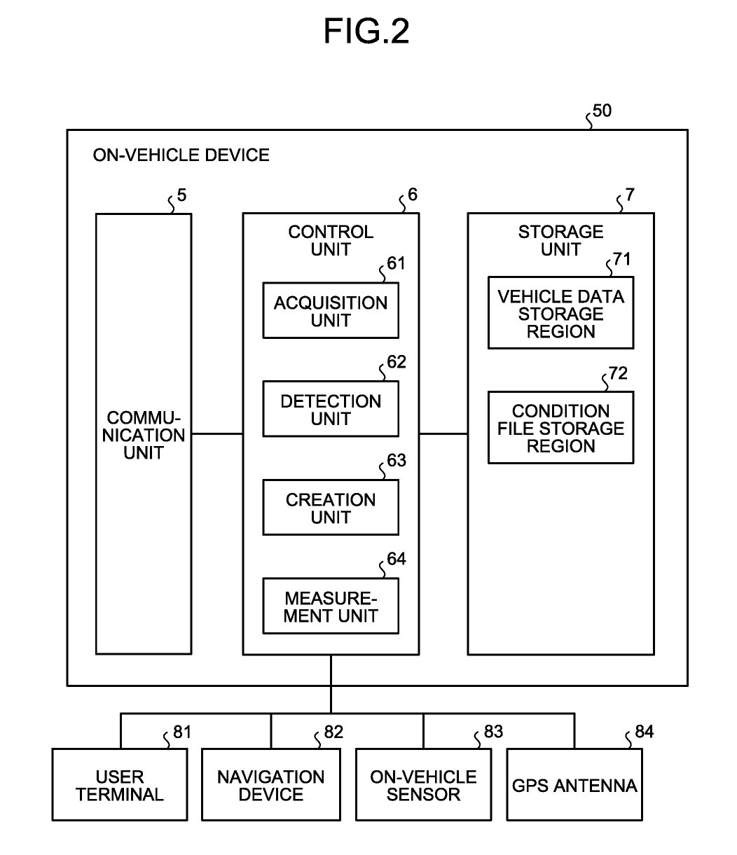

Next, a configuration example of the on-vehicle device 50 according to an embodiment will be explained by using FIG. 2. FIG. 2 is a block diagram of the on-vehicle device 50. As illustrated in FIG. 2, the on-vehicle device 50 is connected to a user terminal 81, a navigation device 82, an on-vehicle sensor 83, and a Global Positioning System (GPS) antenna 84.

The user terminal 81 includes, for example, a smartphone or tablet terminal that is possessed by a user of a vehicle C where it is possible to transmit or receive information by using, for example, the on-vehicle device 50 and a Near Field Communication or the like. For example, the user terminal 81 notifies the on-vehicle device 50 of schedule information of a user that is stored in the user terminal 81.

Schedule information is information that indicates a future schedule of a user and is set by a user in a calendar or the like for the user terminal 81. For example, schedule information includes a starting time and an ending time of a schedule, information of a position where scheduling is executed, a content of a schedule, or the like.

Additionally, the on-vehicle device 50 may acquire schedule information from a cloud server that manages a schedule of a user on a cloud. Furthermore, the on-vehicle device 50 may acquire schedule information based on, for example, information that is registered in a variety of reservation websites for a restaurant, a hair salon, a concert, an airline ticket, a train, or the like.

The navigation device 82 notifies a user of a goal for a vehicle C or a route to the goal. Furthermore, in a case where a goal is set by a user, the navigation device 82 notifies the on-vehicle device 50 of goal information that includes the goal and a running route to the goal, a scheduled time of passage on each running route, or the like.

The on-vehicle sensor 83 is a sensor that detects running data of a vehicle C and outputs the detected running date to the on-vehicle device 50. For example, the on-vehicle sensor 83 includes a vehicle speed sensor that measures a vehicle speed of a vehicle C, a brake sensor that measures a brake situation of the vehicle C, a steering angle sensor that detects a steering angle of the vehicle C, or the like.

Additionally, an on-vehicle sensor may be a sensor that detects a water temperature or a hydraulic pressure of an engine, a sensor that detects a battery voltage of a vehicle C, an acceleration sensor that detects an acceleration of the vehicle C, or an occupant detection sensor that detects an occupant of the vehicle C.

Furthermore, the on-vehicle device 50 may be connected to a camera that captures an image of a surrounding of a vehicle C, a detection device that detects an obstacle around the vehicle C, or the like in addition to the on-vehicle sensor 83.

As for the rest, the on-vehicle device 50 may be connected to an electronic control instrument that executes electronic control of a vehicle C, a chassis system instrument, a body system instrument, a safety system instrument, or an entertainment system instrument. That is, it is possible for the on-vehicle device 50 to acquire every piece of information of a vehicle C.

In other words, in the communication system 100 according to an embodiment, the communication device 1 cooperates with the on-vehicle device 50 so that it is possible to collect a wide variety of information of a vehicle C. Additionally, an electronic control instrument as described above includes an engine control instrument, a transmission control instrument, or the like of a vehicle C and a chassis system instrument includes a steering control instrument or a suspension control instrument.

Furthermore, a body system instrument includes a door control instrument, an air conditioning control instrument, or a security control instrument, and a safety system instrument includes an air-bag control instrument, an automatic driving control instrument, or a driving support control instrument. Furthermore, an entertainment system instrument includes an AV instrument or the like. The GPS antenna 84 notifies the on-vehicle device 50 of position information that indicates a current location of a vehicle C.

The on-vehicle device 50 includes a communication unit 5, a control unit 6, and a storage unit 7. The communication unit 5 executes transmission or receipt of data with the communication device 1 through the network N as described above.

The control unit 6 includes an acquisition unit 61, a detection unit 62, a creation unit 63, and a measurement unit 64. The acquisition unit 61 acquires vehicle data from the on-vehicle sensor 83 and stores them in a vehicle data storage region 71 of the storage unit 7. Furthermore, the acquisition unit 61 acquires a collection condition file from the communication device 1 through the communication unit 5 and stores it in a condition file storage region 72 of the storage unit 7.

The acquisition unit 61 acquires schedule information of a user from the user terminal 81, goal information that indicates a goal or the like of a vehicle C from the navigation device 82, or position information of the vehicle C from the GPS antenna 84, and appropriately transmit it to the communication device 1 through the communication unit 5.

The detection unit 62 detects vehicle data that are a target of collection from vehicle data that are stored in the vehicle data storage region 71. Specifically, the detection unit 62 detects vehicle data that correspond to a starting trigger and an ending trigger of a collection condition file that is stored in the condition file storage region 72, and detects vehicle data from such a starting trigger to such an ending trigger as vehicle data that are a target of collection.

Then, the detection unit 62 notifies the creation unit 63 of information regarding detected vehicle data that are a target of collection. The creation unit 63 creates upload data that are uploaded onto the communication device 1 regarding vehicle data that are a target of collection and are detected by the detection unit 62.

For example, the creation unit 63 causes an identifier, a point of time, position information, or the like for identifying a vehicle C to correspond to vehicle data and subsequently executes reduction according to a reduction method that is specified in a condition setting file as described above, so that upload data are created.

Then, the creation unit 63 uploads upload data onto the communication device 1 through the network N (see FIG. 1B) at timing that is specified by a communication schedule.

Herein, a reduction method in the present embodiment indicates, for example, decimating vehicle data. For example, in a case where the on-vehicle device 50 uploads position information of a vehicle C, position information of each intersection is uploaded and such position information of each intersection is put together by the communication device 1, so that it is possible to restore a running route where the vehicle C runs actually.

Furthermore, for another reduction method, a data difference may be uploaded only in a case where there is a change in data. In such a case, the communication device 1 adds a current difference to a previous value, so that it is possible to restore original data.

That is, the on-vehicle device 50 decimates and uploads vehicle data according to a reduction method, so that it is possible to reduce communication traffic. Then, the communication device 1 restores vehicle data according to a reduction method, so that it is possible to reduce communication traffic and collect vehicle data suitably.

The measurement unit 64 measures a transmission speed in a current communication area at predetermined intervals (for example, every 5 minutes) during a period of time when a power source of the on-vehicle device 50 is turned on. The measurement unit 64 converts a measured transmission speed into, for example, four-level evaluation values, creates transmission speed information where position information of a current location is caused to correspond to such evaluation values, and transmits it to the communication device 1 through the communication unit 5.

Thereby, it is possible for the communication system 100 to acquire an actual measured value of an actual communication quality in each communication area in real time. That is, it is indicated that a tolerance in a communication band for a communication area is provided as a transmission speed is increased and it is indicated that such a communication band is strained as such a transmission speed is decreased.

Additionally, in a case where it is only assumed that the on-vehicle device 50 executes uploading, the measurement unit 64 may measure only an upstream transmission speed. Furthermore, in the communication system 100, in a case where an actual measured value of a transmission speed is provided from a carrier that provides the network N as illustrated in FIG. 1B, it is also possible to omit a configuration of the measurement unit 64.

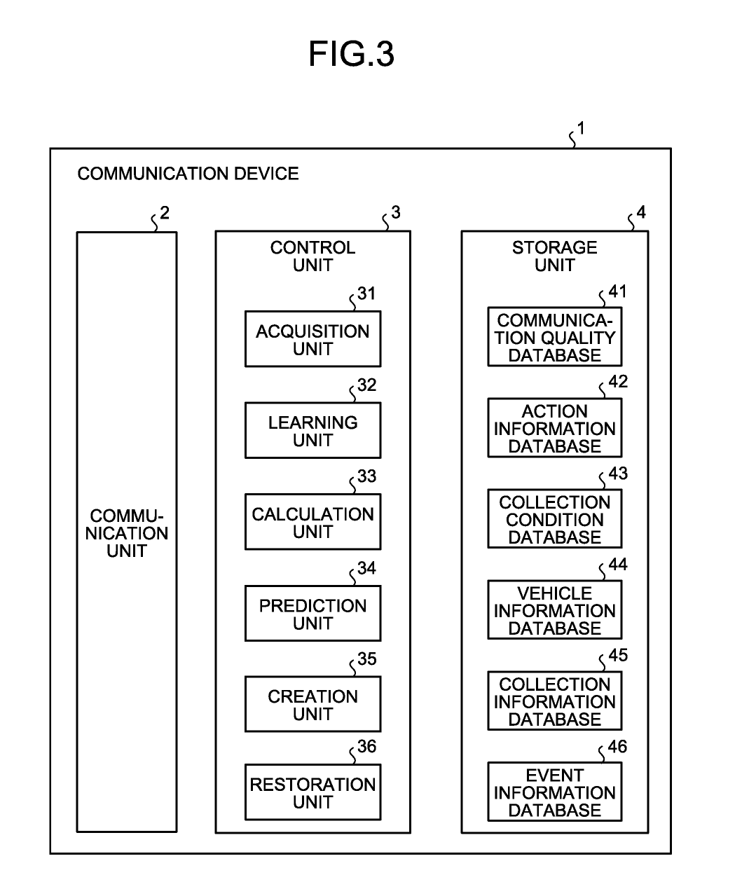

Next, a configuration example of the communication device 1 according to an embodiment will be explained by using FIG. 3. FIG. 3 is a block diagram of the communication device 1. As illustrated in FIG. 3, the communication device 1 includes a communication unit 2, a control unit 3, and a storage unit 4. The communication unit 2 is connected to the network N as described above and executes transmission or receipt of data with each on-vehicle device 50. Furthermore, it is also possible for the communication unit 2 to transmit or receive information with the client device 500.

The control unit 3 includes an acquisition unit 31, a learning unit 32, a calculation unit 33, a prediction unit 34, creation unit 35, and a restoration unit 36. The control unit 3 includes, for example, a computer that has a Central Processing Unit (CPU), a Read Only Memory (ROM), a Random Access Memory (RAM), a Hard Disk Drive (HOD), an input/output port, and the like, and a variety of circuits.

A CPU of a computer reads and executes, for example, a program that is stored in a ROM, and thereby, functions as the acquisition unit 31, the learning unit 32, the calculation unit 33, the prediction unit 34, the creation unit 35, and the restoration unit 36 of the control unit 3.

Furthermore, it is also possible to compose at least one or all of the acquisition unit 31, the learning unit 32, the calculation unit 33, the prediction unit 34, the creation unit 35, and the restoration unit 36 of the control unit 3 of hardware such as an Application Specific Integrated Circuit (ASIC) or a Field Programmable Gate Array (FPGA).

Furthermore, the storage unit 4 corresponds to, for example, a RAM or an HDD. It is possible for a RAM or an HDD to store a communication quality database 41, an action information database 42, a collection condition database 43, a vehicle information database 44, a collection information database 45, and an event information database 46, and information such as a variety of programs. Additionally, the communication device 1 may acquire a program or a variety of information as described above through another computer that is connected by a wired or wireless network or a portable recording medium.

The acquisition unit 31 of the control unit 3 acquires a variety of information from the on-vehicle device 50 or the client device 500. For example, the acquisition unit 31 acquires from the on-vehicle device 50, and stores in the action information database 42, position information of a vehicle C or goal information, schedule information, or the like as described above.

Furthermore, the acquisition unit 31 stores, in the communication quality database 41, transmission speed information that is transmitted from the on-vehicle device 50 at predetermined intervals. Furthermore, the acquisition unit 31 acquires event information from a non-illustrated external server and stores such event information in the event information database 46 of the storage unit 4. Event information refers to, for example, an accident, a traffic regulation, a traffic jam, an event, or a festival.

Furthermore, the acquisition unit 31 acquires upload data from the on-vehicle device 50 and outputs such upload data to the restoration unit 36. Furthermore, the acquisition unit 31 acquires a collection condition from the client device 500 as described above and stores such a collection condition in the collection condition database 43.

The learning unit 32 learns a trend of movement of the on-vehicle device 50 based on a movement history of the on-vehicle device 50. Then, the learning unit 32 stores a result of learning in the action information database 42 of the storage unit 4.

The learning unit 32 derives a regularity of a position where a vehicle C is stopped, a route from a position of a stopped vehicle to a goal, or the like, from a movement history, that is, a history of position information that is transmitted from the on-vehicle device 50.

Herein, it is possible for the learning unit 32 to link a point of time, a day of week, weather, presence or absence of a traffic jam, or the like thereto to derive a regularity as described above. That is, it is possible for the learning unit 32 to learn a trend of movement of the on-vehicle device 50 that is dependent on a point of time, a day of week, weather, or presence or absence of a traffic jam.

Furthermore, the learning unit 32 may acquire information regarding a driver or a passenger of a vehicle C and learn a trend of movement for each driver or each combination of such a driver and such a passenger. That is, it is possible for the learning unit 32 to link a driver or a passenger to a goal for a vehicle C car timing of taking such a vehicle to execute learning.

Additionally, for example, an image that is captured by a (non-illustrated) in-vehicle camera that is placed in a vehicle C is analyzed by the on-vehicle device 50 or the communication device 1 so that it is possible to acquire information regarding a driver or a passenger.

The calculation unit 33 calculates, and notifies the prediction unit 34 of, a probability that the on-vehicle device 50 actually moves on each movement route that is predicted based on a movement history of the on-vehicle device 50. The calculation unit 33 calculates a running probability on each running route based on a trend of movement for each on-vehicle device 50 as described above, for example, at timing when an ignition of a vehicle C is turned on.

Specifically, the calculation unit 33 reads, from the action information database 42, an actual goal in an situation that is identical or similar to a situation where an ignition of a vehicle C is turned on, and a running route to the goal.

Herein, a situation includes, for example, a position where an ignition switch of a vehicle C is turned on, a point of time, a day of week, weather, a driver, presence or absence of a passenger, or the like.

Herein, the calculation unit 33 calculates a running probability on each running route in a case where a plurality of goals are present in a past situation or in a case where a plurality of running routes, even to an identical goal, are present.

For example, the calculation unit 33 calculates a running probability to be high as a frequency of each running route in a past identical situation is high or calculates a running probability to be low as such a frequency is low.

That is, the calculation unit 33 calculates a running probability on each running route based on a movement pattern of a vehicle C that is derived from a past movement history, so that it is possible to calculate a running probability accurately.

In such a case, for example, it is possible for the calculation unit to read event information regarding a running route from the event information database 46 and calculate a running probability based on such event information.

Specifically, in a case where a traffic jam occurs on a running route, it is possible for the calculation unit 33 to calculate a running probability for such a running route and a running probability for a running route to avoid such a traffic jam.

It is possible to calculate them based on a trend of movement of a vehicle C. That is, in a case where a frequency of running of a vehicle C on a running route where a traffic jam occurs in a similar situation is high from a past movement history, a running probability for such a running route is calculated to be high, or in a case where a frequency of running thereof on a running route to avoid a traffic jam is high, a running probability for such a running route is calculated to be high.

That is, the calculation unit 33 calculates a running probability in an irregular case such as occurrence of an event according to a user characteristic. Thereby, it is possible to calculate a running probability accurately.

The prediction unit 34 predicts, and stores in the communication quality database 41 of the storage unit 4, a communication quality on a running route where a running probability is calculated by the calculation unit 33. Additionally, in the present embodiment, running probabilities are calculated for the plurality of on-vehicle devices 50, so that the prediction unit 34 predicts communication qualities for all communication areas.

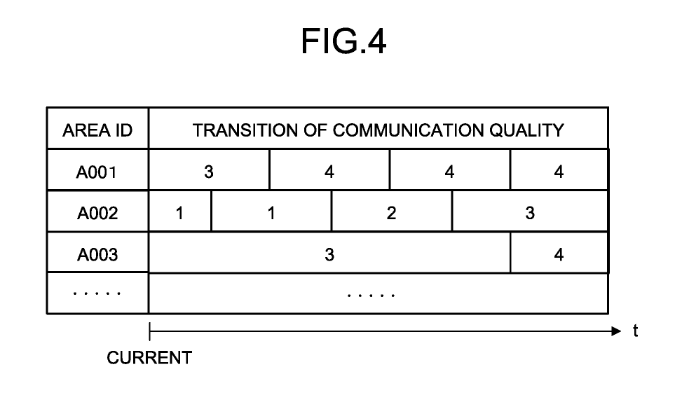

FIG. 4 is a diagram illustrating a specific example of a transition of a communication quality that corresponds to a specific example of information that is stored in the communication quality database 41. As illustrated in FIG. 4, for example, an area ID and a transition of a communication quality are caused to correspond thereto and stored in the communication quality database 41.

An area ID as illustrated in FIG. 4 is an identifier for identifying each communication area and a transition of a communication quality indicates a transition of a communication quality in each communication area that is predicted by the prediction unit 34.

The prediction unit 34 acquires a communication quality in each current communication area based on transmission speed information as described above. Subsequently, the prediction unit 34 predicts a transition of a distribution of vehicles C in each communication area based on a current location of each vehicle C and a running probability as described above.

Herein, in a transition of a distribution of vehicles C, degradation of a communication quality relative to a current communication quality is expected in a communication area where the number of such vehicles C is increased. Furthermore, improvement of a communication quality relative to a current communication quality is expected in a communication area where the number of vehicles C is decreased.

Subsequently, the prediction unit 34 subtracts a transition of communication traffic dependent on a distribution of vehicles C from an upper limit of communication traffic that is communicable per unit time in each communication area, that is, an upper limit of a communication band to predict a transition of a communication quality.

Thus, the prediction unit 34 predicts a transition of a communication quality in each communication area by using transmission speed information, that is, an actual measured value of a transmission speed, so that it is possible to predict a communication quality accurately.

In an example as illustrated in FIG. 4, a communication quality is represented by four levels of “1” to “4” where a larger number indicates a better communication quality. Additionally, al though a communication quality is herein represented by four levels, such a communication quality may be three or less levels or may be five or greater levels.

Additionally, the prediction unit 34 may derive a regularity from a history of a communication quality in each communication area by using, for example, machine learning, and predict a communication quality based on such a regularity.

By returning to an explanation of FIG. 3, the creation unit 35 will be explained. The creation unit 35 creates a communication schedule of data communication of the on-vehicle device 50 based on a running probability on each running route that is calculated by the calculation unit 33 and a communication quality that is predicted by the prediction unit 34.

As the creation unit 35 creates a communication schedule, a collection condition file where a vehicle ID, an address, a method for reducing data, or the like is caused to correspond to a communication schedule is created and transmitted to each on-vehicle device 50 through the communication unit 2 and the network N.

First, the creation unit 35 selects, from the vehicle information database 44, the on-vehicle device 50 that is a target of collection that is specified by a collection condition that is acquired from the client device 500 as illustrated in FIG. 1B.

For example, user information that relates to a user of each on-vehicle device 50 or vehicle information that includes a vehicle type or the like of a vehicle C is stored in the vehicle information database 44. For example, vehicle information is registered in the vehicle information database 44 by a dealer at a time of purchase of the on-vehicle device 50. Alternatively, a user may register user information or vehicle information in the vehicle information database 44 through the Internet.

Subsequently, in a case where a running probability on each running route where the on-vehicle device 50 is capable of running is acquired by the calculation unit 33, that is, a case where an ignition of a vehicle C is turned on, the creation unit 35 creates a communication schedule of the on-vehicle device 50.

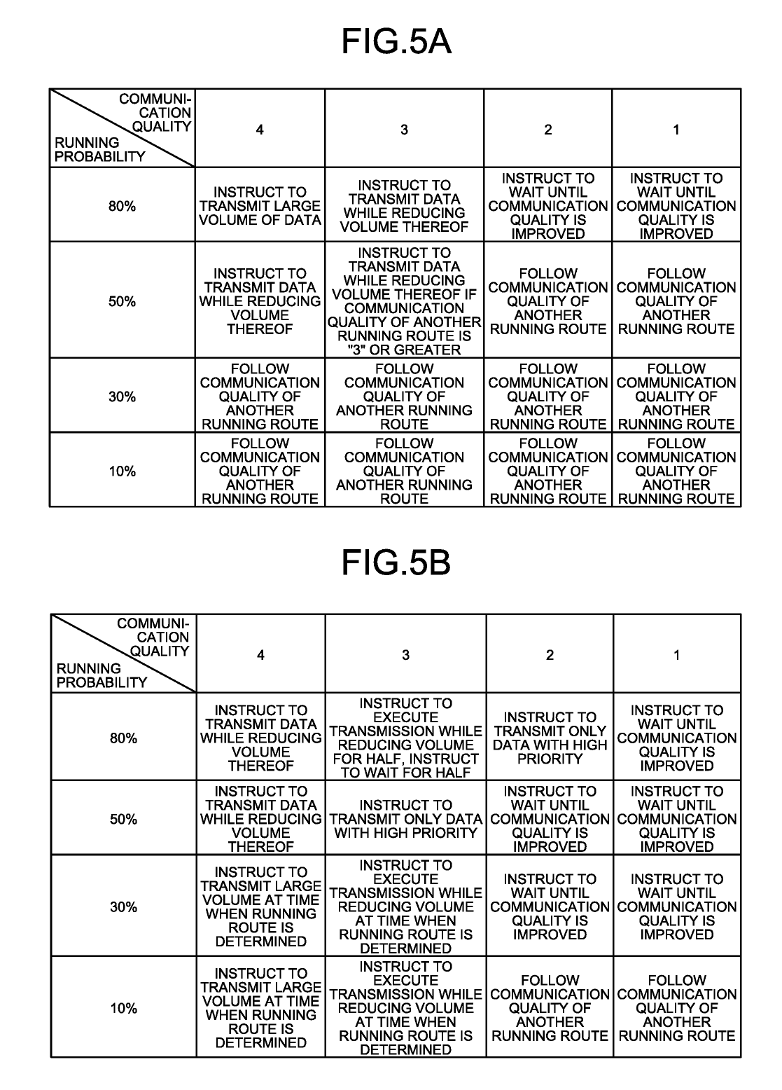

FIG. 5A and FIG. 5B are diagrams illustrating relationships between a running probability and a communication quality. FIG. 5A illustrates a relationship between a running probability and a communication quality that is referred to when a communication schedule is created for one on-vehicle device 50 and FIG. 5B illustrates a relationship between a running probability and a communication quality that is referred to when a plurality of on-vehicle devices 50 run on similar running routes. Furthermore, as described above, a larger number for a communication quality indicates a better communication quality.

The creation unit 35 creates a communication schedule based on a communication quality on a running route with a highest running probability. Specifically, as illustrated in FIG. 5A, for example, in a case where a running probability on a running route with a communication quality that is “4” is 80%, a probability of running on such a running route is high. Hence, the creation unit 35 creates a communication schedule that instructs to transmit a large volume of data at timing of running on such running route.

Furthermore, for example, in a case where a running probability on a running route with a communication quality that is “3” us 80%, the creation unit 35 creates a communication schedule that instructs to transmit data while a volume thereof is reduced as compared with a case where such a communication quality is “4”. Furthermore, for example, in a case where a running probability on a running route with a communication quality that is “2” or “1” is 80%, data transmission is waited for until such a communication quality is improved. That is, in a case where a running probability on a running route with a communication quality that is not good is high, the creation unit 35 creates a communication schedule in such a manner that communication is not executed.

Furthermore, in a case where a running probability on a running route with a communication quality that is “4” is 50%, a communication schedule is created that instructs to transmit data while a volume thereof is reduced. Herein, it is possible for the creation unit 35 to specify a volume to be reduced, depending on a running probability of remaining 50%.

For example, in a case where remaining 50% is a running route with a communication quality of “3”, the creation unit 35 creates a communication schedule that executes transmission while reducing a volume to be reduced, as compared with a case where such remaining 50% is a running route with a communication quality of “2” or “1”.

Furthermore, in a case where a running probability on a running route with a communication quality that is “3” is 50%, a communication schedule is created that instructs to transmit data while a volume thereof is reduced if remaining 50% is of a communication quality of “3” or greater. In other words, in a case where a communication quality of remaining 50% is “3” or “4”, data are transmitted while a volume thereof is reduced.

That is, in such a case, even if a vehicle C runs on a running route with a communication quality that is “3”, a communication schedule is created in such a manner that a communication band is not strained. Furthermore, herein, for example, in a case where remaining 50% is a running route with a communication quality of “2” or less, a communication schedule is created in such a manner that data transmission is not executed.

Furthermore, “FOLLOW COMMUNICATION QUALITY OF ANOTHER RUNNING ROUTE” as illustrated in FIG. 5A indicates that a communication schedule is created according to a communication quality of a running route with a running probability that is highest.

Furthermore, if each of running probabilities on running routes with communication qualities of “4”, “3”, and “2” is 30%, a communication schedule is created that, for example, data transmission is waited for until a running route is determined.

Specifically, for example, after passing through a fork of each running route, a communication schedule is created depending on a communication quality of a running route for running. Thereby, it is possible to create a suitable communication schedule according to an actual running route.

Next, a case where a plurality of vehicles C run on similar running routes will be explained by using FIG. 5B. Herein, a case where each of 100 vehicles C travels to an identical goal will be explained. That is, a running probability herein indicates an expected value of the number of vehicles that pass through respective running routes.

As illustrated in FIG. 5B, in a case where a running probability on a running route with a communication quality that is “4” is 80%, that is, a case where it is predicted that 80 of 100 vehicles C run on such running routes, a communication schedule is created that instructs to transmit data to each on-vehicle device 50 while a volume thereof is reduced.

This is because, if each vehicle C that runs on such a running route transmits a large volume of data, a communication band on such a running route may be strained.

On the other hand, the creation unit 35 reduces a volume, in other words, adjust such a volume, and instructs to execute transmission, so that it is possible to prevent strain of a communication band.

Furthermore, in a case where a running probability on a running route with a communication quality that is “3” is 80%, a communication schedule is created that instructs to execute transmission to a half of the on-vehicle devices 50 while a volume is reduced. Furthermore, a communication schedule is created that causes a remaining half of the on-vehicle devices 50 to wait communication on such a running route.

Additionally, herein, a communication schedule may be created in such a manner that a half of the on-vehicle devices 50 executes data transmission and subsequently a remaining half of the on-vehicle devices 50 executes data transmission.

Furthermore, in a case where a running probability on a running route with a communication quality that is “2” is 80%, a communication schedule is created in such a manner that only data with a high priority is transmitted to each on-vehicle device 50. That is, a communication schedule is created in such a manner that data are selected and transmitted so as to fall within a communication band. Additionally, a priority is a parameter that is specified by the client device 500 as described above.

Furthermore, in a case where a running probability on a running route with a communication quality that is “1” is 80%, data transmission is waited for until such a communication quality is improved. That is, a communication schedule is created in such a manner that data transmission to each on-vehicle device 50 is not executed on such a running route.

Furthermore, in a case where running probabilities on a running route with a communication quality that is “4” are 30% and 10%, a communication schedule is created that instructs to execute large volume transmission in a case where running on such a running route is determined.

This is because a probability of running on such a running route actually, that is, the number of running vehicles C is small so that a possibility of exceeding a communication band is low even if data amount for one of them is increased.

Furthermore, in a case where a running probability on a running route with a communication quality that is “3” is 30%, a communication schedule is created that reduces a volume and instructs to execute transmission at a point of time when running on such a running route is determined.

Thus, the creation unit 35 controls data volumes or upload timing of the plurality of on-vehicle devices 50 so as to fall within a communication band on each running route, that is, in each communication area. Thereby, it is possible to optimize a communication band in each communication area.

By returning to an explanation of FIG. 3, the restoration unit 36 will be explained. The restoration unit 36 restores data that are uploaded from each on-vehicle device 50, according to a reduction method as described above, and stores the restored data in the collection information database 45 of the storage unit 4.

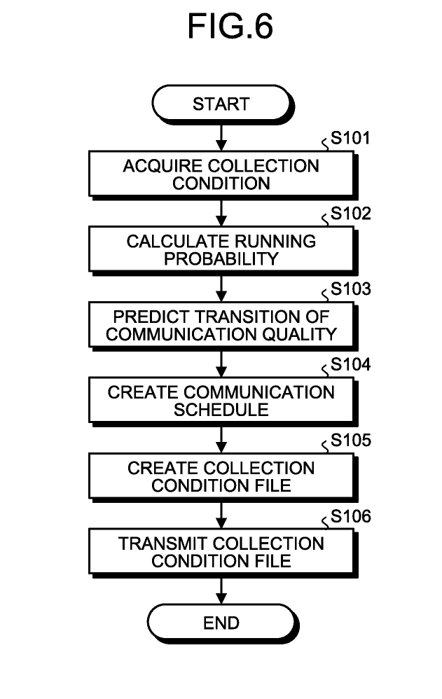

Next, steps of a process that is executed by the communication device 1 according to an embodiment will be explained by using FIG. 6. FIG. 6 is a flowchart illustrating steps of a process that is executed by the communication device 1.

As illustrated in FIG. 6, first, the acquisition unit 31 of the communication device 1 acquires a collection condition from the client device 500 (step S101). Subsequently, the calculation unit 33 calculates a running probability on each running route where a vehicle C is capable of running (step S102).

Subsequently, the prediction unit 34 predicts a transition of a communication quality on each running route (step S103) and the creation unit 35 creates a communication schedule based on a running probability and such a communication quality on each running route (step S104).

Then, the creation unit 35 creates a collection condition file that includes a communication schedule (step S105), transmits such a collection condition file (step S106), and ends such a process.

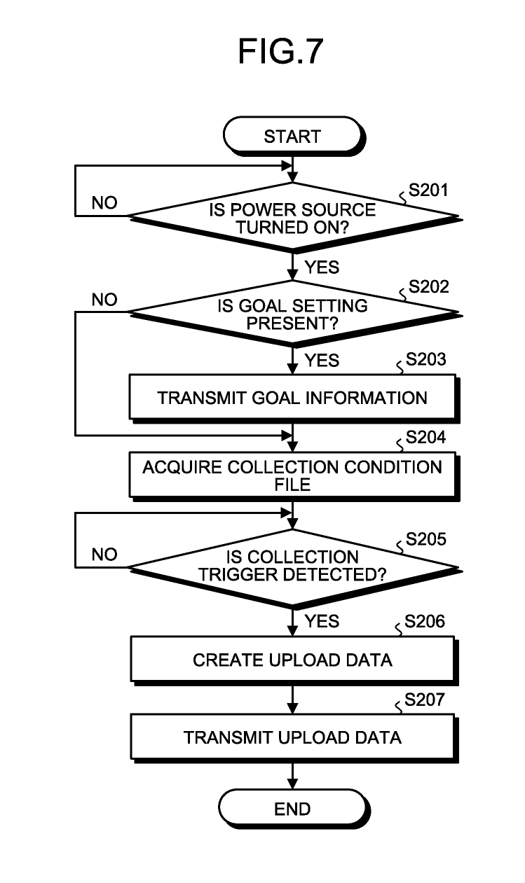

Next, steps of a process that is executed by the on-vehicle device 50 according to an embodiment will be explained by using FIG. 7. FIG. 7 is a flowchart illustrating steps of a process that is executed by the on-vehicle device 50.

As illustrated in FIG. 7, the on-vehicle device 50 determines whether or not a power source is turned on (step S201). In a case where a power source is turned on (step S201, Yes), the on-vehicle device 50 determines whether or not a goal setting is present (step S202).

Herein, in a case where a goal is set (step S202, Yes), the on-vehicle device 50 transmits goal information to the communication device 1 (step S203). On the other hand, in a case where a goal is not set (step S202, No), a process at step S203 is omitted.

Subsequently, the acquisition unit 61 of the on-vehicle device 50 acquires a collection condition file from the communication device 1 (step S204) and the detection unit 62 determines whether or not a collection trigger is detected (step S205).

In a case where the detection unit 62 detects a collection trigger (step S205, Yes), the creation unit 63 creates upload data (step S206), transmits such upload data to the communication device 1 at timing that is specified by a collection condition file (step S207), and ends such a process.

Furthermore, in a case where a power source is turned off in a process at step S201 (step S201, No), such a process at step S201 is repeatedly executed. Furthermore, in a case where the detection unit 62 does not detect a collection trigger in a process at step S205 (step S205, No), for example, a process at step S205 is continuously executed until a power source is turned off.

As described above, the communication device 1 according to an embodiment includes the calculation unit 33, the prediction unit 34, and the creation unit 35. The calculation unit 33 calculates a probability that the on-vehicle device 50 (an example of a terminal device) actually moves on each movement route that is predicted based on a movement history of the on-vehicle device 50. The prediction unit 34 predicts a communication quality on the movement route with a probability that is calculated by the calculation unit 33. The creation unit 35 creates a communication schedule of data communication for the on-vehicle device 50 based on a probability on each movement route that is calculated by the calculation unit 33 and a communication quality that is predicted by the prediction unit 34. Therefore, according to an embodiment, it is possible to optimize a communication band.

Meanwhile, although a case where the communication device 1 creates a communication schedule of data that are uploaded by the on-vehicle device 50 has been explained in an embodiment as described above, this is not limiting. That is, it is also possible for the communication device 1 to create a communication schedule of data that are downloaded by the on-vehicle device 50.

Furthermore, although a case where a terminal device is the on-vehicle device 50 has been explained in an embodiment as described above, such a terminal device may be a communication instrument such as a smartphone or a tablet terminal.

According to an aspect of an embodiment, it is possible to optimize a communication band.

It is possible for a person skilled in the art to readily derive a further effect or variation example. Accordingly, a broader aspect of the present invention is not limited to a specific detail and a representative embodiment as illustrated and described above. Therefore, various modifications are possible without departing from the spirit or scope of a general inventive concept as defined by the appended claims and equivalents thereof.

What is claimed is:

1. A communication device, comprising:
a calculation unit that calculates a probability that a terminal device actually moves on each movement route that is predicted based on a movement history of the terminal device;
a prediction unit that predicts a communication quality on the movement route with the probability that is calculated by the calculation unit; and
a creation unit that creates a communication schedule of data communication for the terminal device based on the probability on each movement route that is calculated by the calculation unit and the communication quality that is predicted by the prediction unit.

2. The communication device according to claim 1, further comprising
a learning unit that learns a trend of movement of the terminal device based on the movement history of the terminal device, wherein
the calculation unit calculates a probability on each movement route based on the trend of movement that is learned by the learning unit.

3. The communication device according to claim 1, wherein the calculation unit calculates a probability on each movement route based on event information that influences the movement route.

4. The communication device according to claim 1, wherein the prediction unit predicts a transition of the communication quality on the movement route based on an actual communication quality that is measured on the movement route.

5. The communication device according to claim 1, wherein the creation unit creates, after the movement route is fixed, the communication schedule based on a transition of a communication quality on a fixed movement route in a case where probabilities of a plurality of movement routes with communication qualities that are different are equal and highest.

6. A schedule creation method, comprising:
calculating a probability that a terminal device actually moves on each movement route that is predicted based on a movement history of the terminal device;
predicting a transition of a communication quality on the movement route with the probability that is calculated in the calculating; and
creating a communication schedule of data communication for the terminal device based on the probability on each movement route that is calculated in the calculating and the transition of a communication quality that is predicted in the predicting.
